(19) United States
(12) Patent Application Publication
(10) Pub. No.: US 2021/0182950 A1
(43) Pub. Date: Jun. 17, 2021

(54) SYSTEM AND METHOD FOR TRANSFORMING IMAGES OF RETAIL ITEMS

(71) Applicant: Myntra Designs Private Limited, Bangalore (IN)

(72) Inventor: Vishnu Vardhan Makkapati, Bangalore (IN)

(21) Appl. No.: 17/247,354

(22) Filed: Dec. 8, 2020

(30) Foreign Application Priority Data
Dec. 16, 2019 (IN) 201941052026

(51) Int. Cl. G06Q 30/06; G06K 9/62; G06N 3/08

(52) U.S. Cl. CPC G06Q 30/0643; G06Q 30/0633; G06N 3/08; G06K 9/6269; G06K 9/6256

(57) ABSTRACT

Systems and method for transforming images of retail items using generative models are presented. The system includes an image acquisition unit and a processor including a training module, a latent vector generator, a latent vector modifier, and an image generator. The image acquisition is configured to access an input image of a selected retail item and a sample target image. The training module is configured to train a generative model. The latent vector generator is configured to generate a first latent vector and a second latent vector from the trained generative model based on the input image of the selected retail item and the sample target image, respectively. The latent vector modifier is configured to modify the second latent vector based on the first latent vector to generate a modified latent vector; and the image generator is configured to generate an output image based on the modified latent vector.

### PRIORITY STATEMENT

The present application hereby claims priority to Indian patent application number 201941052026 filed on 16 Dec. 2019, the entire contents of which are hereby incorporated herein by reference.

### BACKGROUND

Embodiments of the description generally relate to systems and methods for transforming images of retail items, and more particularly to systems and methods for transforming images of retail items using generative models.

On-line shopping (e-commerce) platforms for retail items are well known. Shopping for fashion items on-line is growing in popularity because it potentially offers users a broader range of choice of items in comparison to earlier off-line boutiques and superstores.

Typically, most fashion e-commerce platforms show catalogue images with human models wearing the fashion retail items. The models are shot in various poses and the photos are displayed on the e-commerce platforms. These photoshoots happen in studios and the background and other features of the images are selected according to the retail items and/or brand being shot. However, the process is time consuming and adds to the cost of cataloguing. Moreover, shoppers on e-commerce platforms may want to try out different fashion retail items on them before making an actual on-line purchase of the item. This will give them the experience of “virtual try-on”, which is not easily available on most e-commerce shopping platforms.

Thus, there is a need for systems and methods that enable faster and cost-effective cataloguing of retail items. Further, there is a need for systems and methods that enable the shoppers to virtually try-on the retail items.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for transforming images of retail items is presented. The system includes an image acquisition unit configured to access an input image of a selected retail item and a sample target image. The system further includes a processor operatively coupled to the image acquisition unit. The processor includes a training module, a latent vector generator, a latent vector modifier, and an image generator. The training module is configured to train a generative model using a set of training input images and a set of training target images. The latent vector generator is configured to generate a first latent vector from the trained generative model based on the input image of the selected retail item, and to generate a second latent vector from the trained generative model based on the sample target image. The latent vector modifier is configured to modify the second latent vector based on the first latent vector to generate a modified latent vector; and the image generator is configured to generate an output image based on the modified latent vector.

According to another example embodiment, a system for transforming flat shot images of fashion retail items to catalogue images is presented. The system includes an image acquisition unit configured to receive a flat shot image of a selected fashion retail item and a sample catalogue image. The system further includes a processor operatively coupled to the image acquisition unit. The processor includes a training module, a latent vector generator, a latent vector modifier, and an image generator. The training module is configured to train a generative adversarial network using a set of training flat shot images and a set of training catalogue images. The latent vector generator is configured to generate a first latent vector from the trained generative adversarial network based on the flat shot image of the selected retail item, and to generate a second latent vector from the trained generative adversarial network based on the sample catalogue image. The latent vector modifier is configured to modify the second latent vector based on the first latent vector to generate a modified latent vector; and the image generator is configured to generate an output catalogue image based on the modified latent vector.

According to yet another example embodiment, a method for transforming images of retail items is presented. The method includes training a generative model using a set of training input images and a set of training target images. The method further includes presenting an input image of a selected retail item to the trained generative model to generate a first latent vector; and presenting a sample target image to the trained generative model to generate a second latent vector. The method furthermore includes modifying the second latent vector based on the first latent vector to generate a modified latent vector; and generating an output image based on the modified latent vector.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating a system for transforming images of retail items, according to some aspects of the present description,

FIG. 2 is a flow chart illustrating a method for transforming images of retail items, according to some aspects of the present description,

FIG. 3 illustrates an example embodiment for generating a catalogue image of a dress from a flat shot image of the dress, according to some aspects of the present description,

FIG. 4 illustrates an example embodiment for generating a catalogue image of a dress from a flat shot image of the dress, according to some aspects of the present description,

FIG. 5 illustrates an example embodiment for generating a plurality of catalogue images with different model poses from a flat shot image of a dress, according to some aspects of the present description,

FIG. 6 illustrates an example embodiment for generating a plurality of catalogue images with different model poses and accessories from a flat shot image of a dress, according to some aspects of the present description,

FIG. 7 illustrates an example embodiment for generating a catalogue image of a hand bag from a flat shot image of the hand bag, according to some aspects of the present description,

FIG. 8 illustrates an example embodiment for generating a catalogue image of a dress from an image of a mannequin wearing the dress, according to some aspects of the present description,

FIG. 9 illustrates an example embodiment for generating an image of a shopper wearing a dress from a flat shot image of the dress, according to some aspects of the present description, and

FIG. 10 illustrates an example embodiment for generating a flat shot image of a dress from a catalogue image of the dress, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Example embodiments of the present description present systems and methods for transforming images of retail items using generative models.

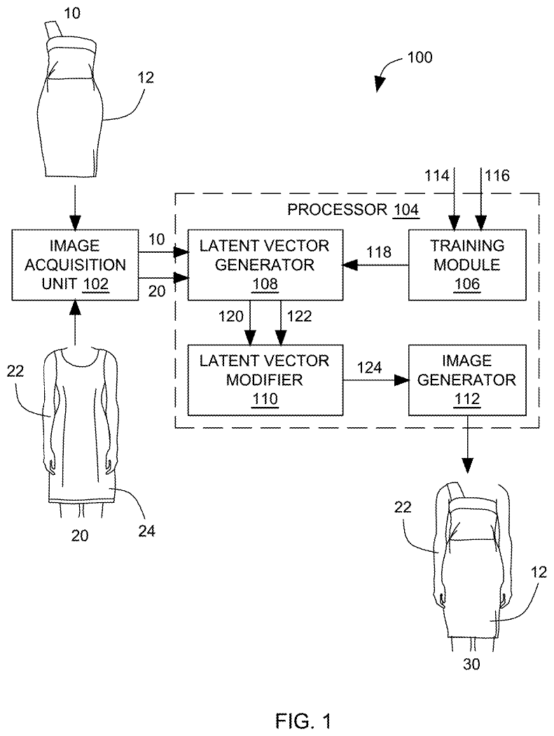

FIG. 1 is a block diagram of a system 100 for transforming images of retail items using generative models. The system 100 includes an image acquisition unit 102 and a processor 104 operatively coupled to the image acquisition unit 102. The processor 104 further includes a training module 106, a latent vector generator 108, a latent vector modifier 110, and an image generator 112. The image acquisition unit 102 and the components of the processor 104 are described in further detail below.

The image acquisition unit 102 is configured to access an input image 10 of a selected retail item 12 and a sample target image 20. The term “selected retail item” as used herein refers to a retail item whose image needs to be transformed by the systems and methods described herein. Non-limiting examples of retail items include fashion retail items, furniture items, decorative items, linen, furnishing (carpets, cushions, and curtains), lamps, tableware, and the like. In one embodiment, the selected retail item is a fashion retail item. Non-limiting examples of fashion retail items include garments (such as top wear, bottom wear, and the like), accessories (such as scarves, belts, socks, sunglasses, and bags), jewelry, foot wear and the like.

In one embodiment, the input image 10 of the selected retail item is captured in real time by a suitable imaging device (not shown). The imaging device may include a camera configured to capture visible, infrared, or ultraviolet light. The image acquisition unit 102 in such instances may be configured to access the imaging device and the input image 10 in real time. In another embodiment, the input image 10 of the selected retail item is stored in an input image repository (not shown) either locally (e.g., in a memory coupled to the processor 104) or in a remote location (e.g., cloud storage, offline image repository and the like). The image acquisition unit 102 in such instances may be configured to access the input image repository to retrieve the input image 10.

The input image 10 may be a standalone image of the selected retail item 12 in one embodiment. The term “standalone image” as used herein refers to the image of the selected retail item by itself. In embodiments related to fashion retail items, the “standalone image” does not include a model or a mannequin. In certain embodiments, the input image 10 may be a flat shot image of the selected retail item. The flat shot images may be taken from any suitable angle and include top-views, side views, front-views, back-views, and the like. In another embodiment related to a fashion retail item, the input image 10 may be an image of a mannequin wearing the selected retail item 12. The input images 10 as described herein are applicable to embodiments related to transformation of images (standalone or mannequin-based) to catalogue images or virtual try-on images. For embodiments related to transformation of catalogue images to standalone images of the retail items, the input image 10 is a catalogue image of the selected retail item.

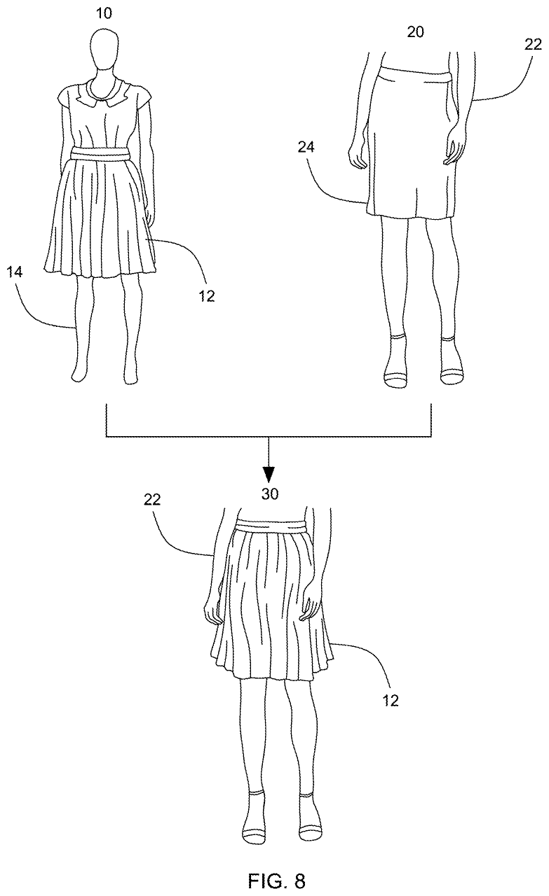

In the example embodiment illustrated in FIG. 1, the selected retail item 12 is shown as a dress and the input image 10 as a flat shot image of the front view of the dress. However, as noted earlier, any retail item is within the scope of the present description. Further, the input image 10 may be a standalone image of the selected retail item taken from any suitable angle. Alternatively, in embodiments related to fashion retail items, the input image 10 could also be an image of a mannequin wearing the selected fashion retail item, as shown in FIG. 8.

With continued reference to FIG. 1, the image acquisition unit 102 is further configured to access a sample target image 20. The term “sample target image” as used herein refers to an image having one or more characteristics that are desired in the image after transformation. For example, for retail items such as furniture items, the sample target image 20 may have the desired background required in the final output image. Similarly, for cataloguing of fashion retail items, the sample target image 20 may have the characteristics (e.g., model attributes, background etc) desired for the final catalogue image. Alternatively, for embodiments related to shoppers virtually trying on the selected retail items, the sample target image 20 may be an image of the shopper. In one embodiment, the sample target image 20 is an image of a model wearing another retail item. In another embodiment, the sample target image 20 is an image of a shopper wearing another retail item.

The sample target image 20 may be stored in a sample target image repository (not shown) either locally (e.g., in a memory coupled to the processor 104) or in a remote location (e.g., cloud storage, offline image repository and the like). The image acquisition unit 102 in such instances may be configured to access the sample target image repository to retrieve the sample target image 20. Alternatively, for embodiments related to shoppers virtually trying on the selected retail items, the sample target image 20 may be provided by the shopper. In such instances, the image acquisition unit 102 may be configured to access the sample target image 20 from the user interface where the shopper has uploaded the sample target image 20.

Referring back to FIG. 1, the processor 104 is communicatively coupled to the image acquisition unit 102. The processor includes a training module 106 configured to train a generative model using a set of training input images 114 and a set of training target images 116. The term “generative model” as used herein refers to a machine learning model that is able to replicate or generate new data instances. Non-limiting examples of suitable generative models include a Generative Adversarial Network, a cycle Generative Adversarial Network, or a bidirectional Generative Adversarial Network. In one embodiment, the generative model is a Generative Adversarial Network (GAN).

The processor 104 further includes a latent vector generator 108 that is communicatively coupled to the image acquisition unit 102 and the training module 106. The latent vector generator 108 is configured to receive the input image 10 and the sample target image 20 from the image acquisition unit 102. The latent vector generator 108 is further configured to receive the trained generative model 118 from the training module 106, and present the input image 10 and the sample target image 20 to the trained generative model. The latent vector generator 108 is furthermore configured to generate a first latent vector 120 from the trained generative model 118 based on the input image 10 of the selected retail item 12, and to generate a second latent vector 122 from the trained generative model 118 based on the sample target image 20.

The latent vector generator 108 is communicatively coupled to a latent vector modifier 110. The latent vector modifier 110 is configured to modify the second latent vector 122 based on the first latent vector 120 to generate a modified latent vector 124. The processor 104 further includes an image generator 112 configured to generate an output image 30 based on the modified latent vector 124.

Referring again to FIG. 1, in one embodiment, a system 100 for transforming flat shot images of fashion retail items to catalogue images is presented. The system 100 includes an image acquisition unit 102 configured to receive a flat shot image 10 of a selected fashion retail item 12 and a sample catalogue image 20. The system further includes a processor 104 operatively coupled to the image acquisition unit 102. The processor 104 includes a training module 106, a latent vector generator 108, a latent vector modifier 110, and an image generator 112. The training module 106 is configured to train a generative adversarial network using a set of training flat shot images 114 and a set of training catalogue images 116. The latent vector generator 108 is configured to generate a first latent vector 120 from the trained generative adversarial network 118 based on the flat shot image 10 of the selected retail item 12, and to generate a second latent vector 122 from the trained generative adversarial network 118 based on the sample catalogue image 20. The latent vector modifier 110 is configured to modify the second latent vector 122 based on the first latent vector 120 to generate a modified latent vector 124; and the image generator 112 is configured to generate an output catalogue image 30 based on the modified latent vector 124.

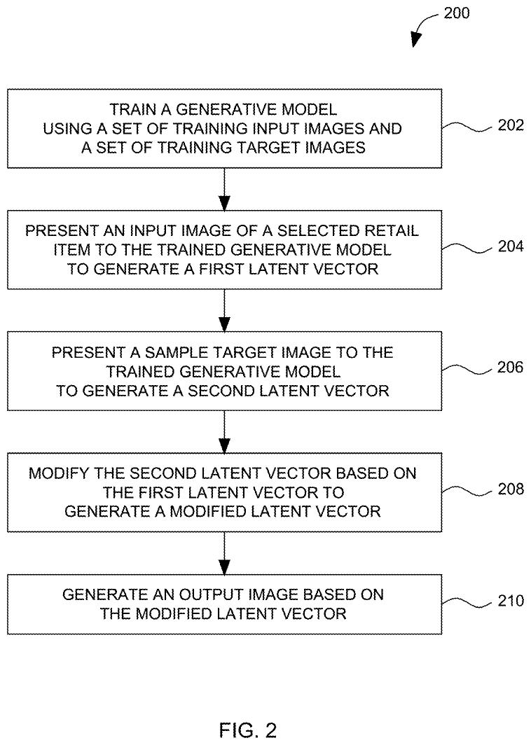

The manner of implementation of the system 100 is described below in FIGS. 2-10. FIG. 2 is a flowchart illustrating a method 200 for transforming images of retail items. The method 200 may be implemented using the system of FIG. 1, according to some aspects of the present description. Each step of the method 200 is described in detail below.

The method 200 includes, at step 202, training a generative model using a set of training input images 114 and a set of training target images 116. Non-limiting examples of suitable generative models include a Generative Adversarial Network, a cycle Generative Adversarial Network, or a bidirectional Generative Adversarial Network. In one embodiment, the generative model is a generative adversarial network (GAN).

A Generative Adversarial Network is neural network that includes a generative network and a discriminative network. A GAN may be used to generate images that look similar to the input data set by training the generator network and the discriminative network in competition. The generative network generates candidates (e.g., images) while the discriminative network evaluates them. Typically, the generative network learns to map from a latent space to a data distribution of interest, while the discriminative network distinguishes candidates (e.g., images) produced by the generator from the true data distribution. The generative network's training objective is to increase the error rate of the discriminative network, i.e., outwit the discriminator network by producing new images that the discriminator thinks are not synthesized (are part of the true data distribution). Backpropagation may be applied in both networks so that the generator produces better images, while the discriminator becomes more skilled at flagging synthetic images. The generator network and the discriminator network are trained until an equilibrium is reached. The trained network may be further used to generate a latent vector based on an image provided. The term “latent vector” as used herein refers to a dependent variable, whose value depends on a much smaller set of variables with a simpler probability distribution, like a vector of a dozen unit normal gaussians. This vector is typically denoted as “z”, the latent vector. Following the training of the GAN, the generator network can generate an image from a given latent vector.

In one embodiment, the method includes at step 202 initializing the GAN in the training module 106 and training the GAN using a set of training input images 114 and a set of training target images 116. This ensures that the generator network is capable of generating both the input and target images. Since both these types of images are in the distribution learnt by the generator network, latent vectors corresponding to both the input and target images can be estimated using known methods. In one embodiment, the set of training input images 114 include standalone images of one or more retail items. As noted earlier, the term “standalone images” as used herein refers to the images of the one or more retail items by themselves. In embodiments related to fashion retail items, the “standalone images” do not include a model or a mannequin. In certain embodiments, set of training input images 114 may be flat shot images of the selected retail items. The flat shot images may be taken from any suitable angle and include top-views, side views, front-views, back-views, and the like. In another embodiment related to fashion retail items, the set of training input images 114 may be images of mannequins wearing the one or more retail items.

The set of training target images 116, in such embodiments include corresponding catalogue images of the one or more retail items. The term “catalogue images” as used herein refers to images of the one or more retail items with the appropriate background etc for display in a product catalogue (either a printed catalogue or a digital catalogue). For example, for embodiments related to fashion retail items, the term “catalogue images” refers to images of the one or more retail items as worn by a model. The set of input training images 114 and the set of training target images 116 is presented to the generative model (e.g., GAN) in the training module 106, at step 202, and the model is trained to generate a trained generative model 118.

The method 200 further includes, at step 204, presenting an input image 10 of a selected retail item 12 to the trained generative model (e.g., a trained GAN) to generate a first latent vector 120. The first latent vector may also be represented as “z_i.” The input image 10 may be accessed by the image acquisition unit 102 as discussed earlier and presented to the latent vector generator 108.

For embodiments related to cataloguing of the selected retail items, the input image 10 may be selected by the user responsible for generating catalogue content. In such instances, the user may choose the input image 10 from an input image repository (not shown), or may capture the image 10 of the selected retail item 12 in real-time using a suitable imaging device. As mentioned earlier, the input image 10 may be a standalone image of the selected retail item 12 (e.g., a flat shot image) or may be an image of a mannequin wearing the selected retail item 12. Further, the input images 10 may have been captured at various angles and the user may choose the appropriate input image based on the desired output catalogue image. The chosen image may be accessed by the image acquisition unit 102 as the input image 10 and presented to the trained generative model 118 in the latent vector generator 108. For embodiments related to transformation of catalogue images to standalone images of the retail items, the input image 10 may be a catalogue image of the selected retail item 12 and the user may choose the input image from a repository of catalogue images.

Alternatively, for embodiments related to virtual try-on by the shopper, the input image 10 of the selected retail item may be chosen by the shopper, e.g., on an e-commerce platform (e.g., a web site, a mobile page, or an app). The shopper may search or browse the catalogue of retail items on the e-commerce platform and may select (e.g., by clicking on) an image of the selected retail item 12. The selected image may be accessed by the image acquisition unit 102 as the input image 10 and presented to the trained generative model 118 in the latent vector generator 108.

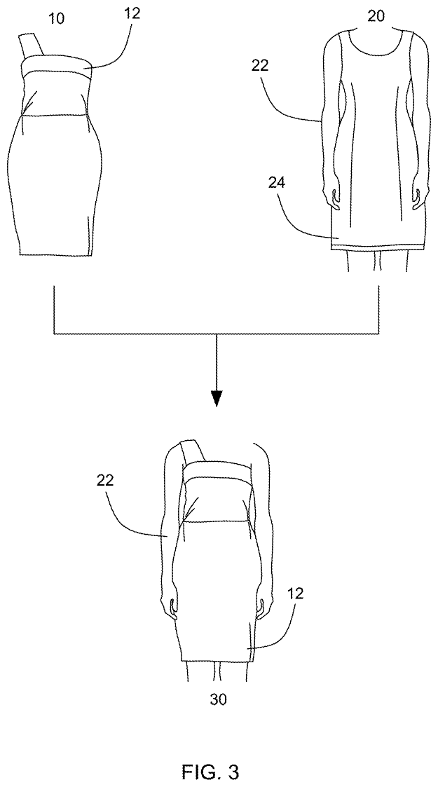

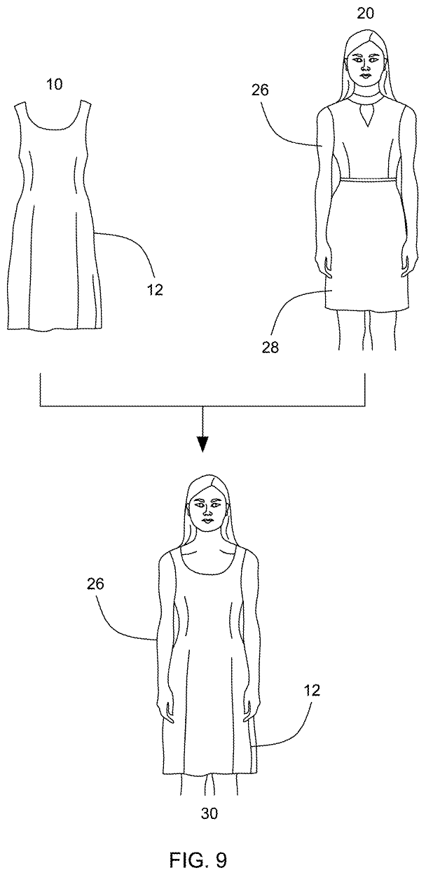

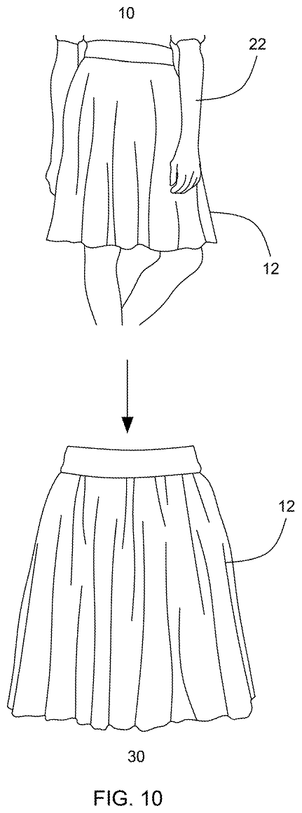

FIGS. 3-10 illustrate examples of different input images 10 according to embodiments of the present description. FIGS. 3-7 show example embodiments where flat shot images of a selected retail item 12 are used as input images 10 to generate output catalogue images 30 of a model 22 wearing the selected retail item 12. FIG. 8 shows an example embodiment where an image of a mannequin 14 wearing the selected retail item 12 is used as the input image 10 to generate the output catalogue image 30 of a model 22 wearing the selected retail item 12. FIG. 9 shows an embodiment where a flat shot image of a selected retail item 12 is used as an input image 10 to generate an output image 30 of a shopper 26 wearing the selected retail item 12. FIG. 10 shows an embodiment where a catalogue image of a model 22 wearing the selected retail item 12 is used as an input image 10.

The method 200 further includes, at step 206, presenting a sample target image 20 to the trained generative model (e.g., a trained GAN) 118 to generate a second latent vector 122. The second latent vector may also be represented as “z_t.” The sample target image 20 may be accessed by the image acquisition unit 102 as discussed earlier and presented to the latent vector generator 108.

For embodiments related to cataloguing of the selected retail items, the sample target mage 20 is a sample catalogue image, and is selected based on one or more desired characteristics. In one embodiment, the sample target image 20 is an image of a model wearing another retail item. In such instances, the sample target image may be selected by the user responsible for generating catalogue content. The user may choose the sample target image 20 from a sample target image repository based on one or more desired characteristics of the output catalogue image. For example, for retail items such as furniture items the sample target image 20 may have the desired background required in the final output image. Similarly, for cataloguing of fashion retail items, the sample target image 20 may have the characteristics (e.g., model attributes, background etc) desired for the final catalogue image. In one example embodiment related to fashion retail items, the one or more desired characteristics include model pose, model skin tone, model body weight, model body shape, other retail items worn by the model, or background of the catalogue image. The selected image may be accessed by the image acquisition unit 102 as the sample target image 10 and presented to the trained generative model 118 in the latent vector generator 108. FIGS. 3-5 and 8 show example embodiments where images of a model 22 wearing another retail item 24 are used as sample target images 20.

Alternatively, for embodiments related to virtual try-on by the shopper, the sample target image 20 is an image of the shopper wearing another retail item. In such instances, the sample target image 20 may be uploaded by the shopper, e.g., on the user interface of an e-commerce web platform (e.g., a web site, a mobile page, or an app). The uploaded image may be accessed by the image acquisition unit 102 as sample target image 20 and presented to the trained generative model 118 in the latent vector generator 108. FIG. 9 shows an embodiment where an image of a shopper 26 wearing another retail item 28 is used as the sample target image 20.

Referring again to FIG. 2, the method 200 further includes, at step 208, modifying the second latent vector 122 based on the first latent vector 120 to generate a modified latent vector 124. As mentioned earlier, the latent vector generator generates a first latent vector z_i and a second latent vector z_t. The latent vector modifier modifies the second latent vector z_t by determining the part of z_t that corresponds to the other retail item 24, 28 worn by the model 22 or the shopper 26. This part is replaced with z_i to generate the modified latent vector z_m. This can be achieved via several means. For every catalogue image for which the corresponding flat shot image is available (most e-commerce platforms have these images), the latent vector of the flat shot image can be subtracted from that of the catalogue image (z_t) to obtain the resultant latent vector. The latent vector of the retail image (z_i) to be transformed can be added to the resultant latent vector to give the modified latent vector (z_m). In cases where the flat shot image is not available, e.g., for a customer uploaded image, suitable methods may be used to modify the corresponding latent vector.

The method 200, further includes at step 210, generating an output image 30 based on the modified latent vector 124 (z_m). The method may further include displaying the output image 30 on a display unit to the user or the shopper. FIGS. 3-8 show the output catalogue images 30 of a model 22 wearing the selected retail item 12. FIG. 9 shows the output image 30 as an image of the shopper 26 wearing the selected retail item 12. FIG. 10 shows the output image 30 as a standalone image of the selected retail item 12.

For embodiments related to cataloguing of the selected retail items, the output image 30 may be further stored in a repository. In some embodiments, the steps 202 to 210 of the method 200 in such cases may be repeated for other input images 10 of the selected retail item 12 (e.g., with other angles) or for other selected target images 20 (e.g., with different model pose, accessories, background etc.) In some other embodiments, the user may select another retail item and steps 202 to 210 of the method 200 may be repeated for input images 10 of the other selected retail item resulting in a library of catalogue images of different retail items. The output images 30 may be incorporated into a catalogue layout and printed; or a plurality of static web pages including one or more output catalogue images may be generated, and those web pages may be served to visitors on an e-commerce platform (e.g., a web site, a mobile page, or an app). Thus, the systems and methods of the present description, may enable faster and cost-effective cataloguing of retail items, by digitally generating catalogue image data, and thus obviating the need for actual photo shoots.

For embodiments related to virtual try-on of the selected retail item 12, the output image 30 may be displayed to the shopper on an e-commerce platform. If the shopper decides to purchase the selected retail item 12, the information regarding the selected retail item 12 may be passed to an order-fulfillment process for subsequent activity. Alternately, the shopper may decide not to purchase the selected retail item and may choose another retail item for virtual try-on. In such instances, the steps 202-210 of the method 200 may be repeated for another retail item selected by the shopper. Thus, the systems and methods of the present description may enable the shopper to virtually try-on the selected retail items by generating images of the shopper wearing the selected retail items.

The different embodiments according to the present description are further illustrated in FIGS. 3-10.

FIG. 3 illustrates an example embodiment for generating a catalogue image of a dress 12 from a flat shot image 10 of the dress 12. As mentioned earlier, although the image 10 shows a front view of the dress 12, systems and methods of the present description are applicable for images taken from different angles (e.g., top view, side view, back view) as well. The flat shot image 10 of the dress 12 is presented to the latent vector generator 108 of FIG. 1 to generate a first latent vector 120 (z_i). Further, the image 20 of a model 22 wearing another dress 24 of a different style is selected as the sample target image 20. The sample target image 20 in this instance may be chosen, e.g., based on the desired pose of the model 22 in the output catalogue image 30. This sample target image 20 is presented to the latent vector generator 108 of FIG. 1 to generate a second latent vector 120 (z_t). The latent vector modifier 110 of FIG. 1 modifies the z_t by replacing the part of z_t that corresponds to the dress 24 with the latent vector z_i, thereby generating a modified latent vector 124 (z_m). The modified latent vector z_m is used to generate the output catalogue image 30 that now shows the model 22 wearing the dress 12.

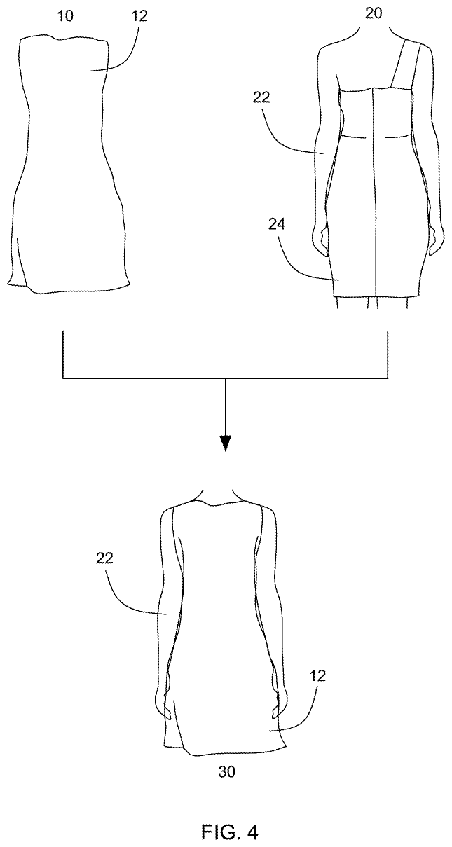

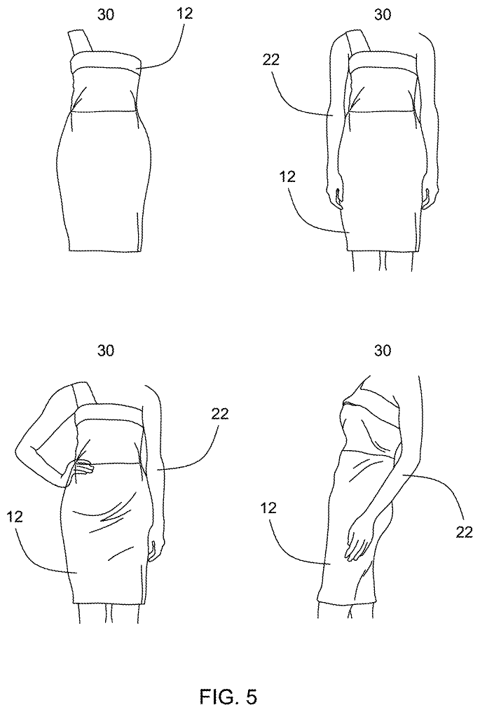

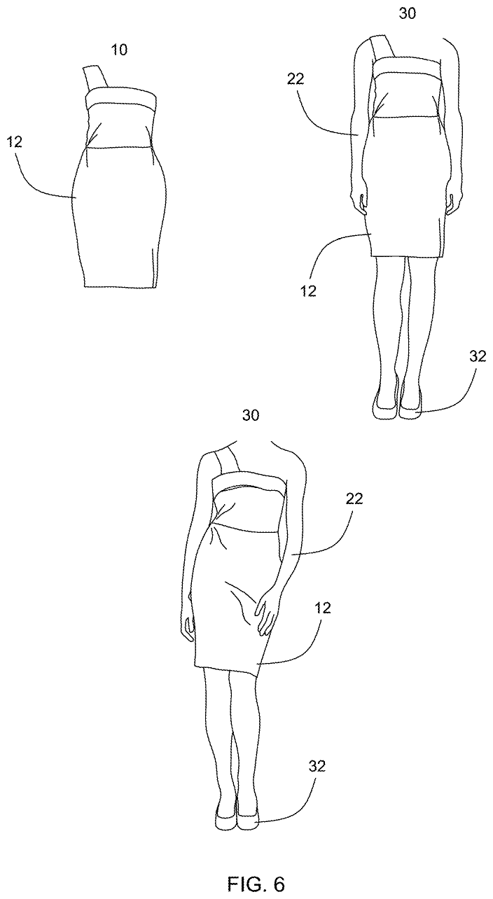

FIG. 4-6 illustrate example embodiments where output catalogue images 30 with different model poses and/or accessories may be generated using a single input image. FIG. 4 illustrates an embodiment for generation of a catalogue image of a dress 12 from a flat shot image 10 of the dress 12 except that the model pose in the output catalogue image 30 is changed, i.e., the back of the model is shown. FIG. 5 shows an embodiment where different output catalogue images 30 with different model poses (including whether the model is facing the camera or turned to one side, or the position of the arms or legs) are generated. FIG. 6 shows an embodiment where catalogue images 30 with different combinations of accessories 32 (e.g., shoes) and model poses are generated from the flat shot image 10 of the selected dress 12, using the embodiments described herein.

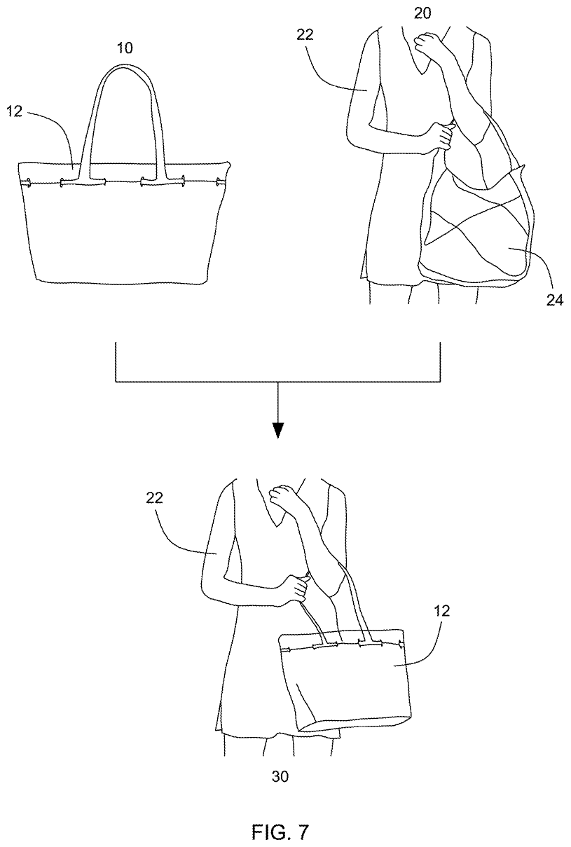

FIG. 7 illustrates an example embodiment for generating a catalogue image of a hand bag 12 from a flat shot image 10 of the hand bag 12. Similar to FIG. 3, a flat shot image 10 of the hand bag 12 is presented to the latent vector generator 108 of FIG. 1 to generate a first latent vector 120 (z_i). Further, the image 20 of a model 22 holding another hand bag 24 of a different style is selected as the sample target image 20. The sample target image 20 in this instance may be chosen, e.g., based on the desired pose of the model 22 in the output catalogue image 30. This sample target image 20 is presented to the latent vector generator 108 of FIG. 1 to generate a second latent vector 120 (z_t). The latent vector modifier 110 of FIG. 1 modifies the z_t by replacing the part of z_t that corresponds to the hand bag 24 with the latent vector z_i, thereby generating a modified latent vector 124 (z_m). The modified latent vector z_m is used to generate the output catalogue image 30 that now shows the model 22 holding the hand bag 12.

FIG. 8 shows an example embodiment where the input image 10 is an image of a mannequin 14 wearing a skirt 12. The image 10 of the mannequin 14 is presented to the latent vector generator 108 of FIG. 1 to generate a first latent vector 120 (z_i). Further, the image 20 of a model 22 wearing another skirt 24 of a different style is selected as the sample target image 20. The sample target image 20 in this instance may be chosen, e.g., based on the desired pose of the model 22 in the output catalogue image 30. This sample target image 20 is presented to the latent vector generator 108 of FIG. 1 to generate a second latent vector 120 (z_t). The latent vector modifier 110 of FIG. 1 modifies the z_t by replacing the part of z_t that corresponds to the skirt 24 with the latent vector corresponding to the skirt 12 in z_i, thereby generating a modified latent vector 124 (z_m). The modified latent vector z_m is used to generate the output catalogue image 30 that now shows the model 22 wearing the skirt 12.

FIG. 9 illustrates an example embodiment that enables a shopper 26 to virtually try-on a dress 12. The flat shot image 10 of the dress 12 is presented to the latent vector generator 108 of FIG. 1 to generate a first latent vector 120 (z_i). Further, the image 20 of the shopper 26 wearing another dress 28 of a different style is presented to the latent vector generator 108 of FIG. 1 to generate a second latent vector 120 (z_t). The sample target image 20 in this instance may be provided by the shopper 26. The latent vector modifier 110 of FIG. 1 modifies the z_t by replacing the part of z_t that corresponds to the dress 28 with the latent vector z_i, thereby generating a modified latent vector 124 (z_m). The modified latent vector z_m is used to generate the output image 30 that now shows the shopper 26 wearing the dress 12.

FIG. 10 illustrates an embodiment for generating a standalone image 30 of a skirt 12 from a catalogue image 10 of the skirt 12.

The system(s), described herein, may be realized by hardware elements, software elements and/or combinations thereof. For example, the modules and components illustrated in the example embodiments may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Embodiments of the present description provide for improved systems and methods for generating image data for e-commerce platforms. More specifically, systems and methods of the present description, according to some embodiments, may enable faster and cost-effective cataloguing of retail items, by generating image data using generative models, and thus obviating the need for actual photo shoots. Further, in some embodiments, systems and methods of the present description may enable a shopper to virtually try-on fashion retail items by generating an image of the shopper wearing the selected retail item using generative models.

While only certain features of several embodiments have been illustrated, and described herein, many modifications and changes will occur to those skilled in the art. It is, therefore, to be understood that the appended claims are intended to cover all such modifications and changes as fall within the scope of the invention and the appended claims.

1. A system for transforming images of retail items, the system comprising:
an image acquisition unit configured to access an input image of a selected retail item and a sample target image; and
a processor operatively coupled to the image acquisition unit, the processor comprising:
a training module configured to train a generative model using a set of training input images and a set of training target images;
a latent vector generator configured to generate a first latent vector from the trained generative model based on the input image of the selected retail item, and to generate a second latent vector from the trained generative model based on the sample target image;
a latent vector modifier configured to modify the second latent vector based on the first latent vector to generate a modified latent vector; and
an image generator configured to generate an output image based on the modified latent vector.

2. The system of claim 1, wherein the set of training input images comprise standalone images of one or more retail items or images of mannequins wearing the one or more retail items, and the set of training target images comprise corresponding catalogue images of the one or more retail items.

3. The system of claim 1, wherein the input image of the selected retail item is a standalone image of the selected retail item or an image of a mannequin wearing the selected retail item, and the output image is a catalogue image of a model wearing the selected retail item.

4. The system of claim 3, wherein the sample target image is a sample catalogue image of the model wearing another retail item, and is selected based one or more desired characteristics.

5. The system of claim 4, wherein the one on more desired characteristics comprise model pose, model skin tone, model body weight, model body shape, other retail items worn by the model, or background of the catalogue image.

6. The system of claim 1, wherein the input image of the selected retail item is a standalone image of the selected retail item or an image of a mannequin wearing the selected retail item, and the output image is an image of the selected retail item worn by a shopper.

7. The system of claim 6, wherein the sample target image is an image of the shopper wearing another retail item, and is provided by the shopper.

8. The system of claim 1, wherein the input image of the selected retail item is a catalogue image of the selected retail item and the output image is a standalone image of the selected retail item.

9. The system of claim 1, wherein the generative model is a generative adversarial network, a cycle generative adversarial network, or a bidirectional generative adversarial network.

10. A system for transforming flat shot images of fashion retail items to catalogue images, the system comprising:
an image acquisition unit configured to receive a flat shot image of a selected fashion retail item and a sample catalogue image; and
a processor operatively coupled to the image acquisition unit, the processor comprising:
a training module configured to train a generative adversarial network using a set of training flat shot images and a set of training catalogue images;
a latent vector generator configured to generate a first latent vector from the trained generative adversarial network based on the flat shot image of the selected fashion retail item, and to generate a second latent vector from the trained generative adversarial network based on the sample catalogue image;
a latent vector modifier configured to modify the second latent vector based on the first latent vector to generate a modified latent vector; and
an image generator configured to generate an output catalogue image of a model wearing the selected retail item, based on the modified latent vector.

11. The system of claim 10, wherein the sample catalogue image is an image of the model wearing another fashion retail item, and is selected based one or more desired characteristics.

12. The system of claim 11, wherein the one on more desired characteristics comprise model pose, model skin tone, model body weight, model body shape, accessories worn by the model, or background of the output catalogue image.

13. A method for transforming images of retail items, comprising:
training a generative model using a set of training input images and a set of training target images;
presenting an input image of a selected retail item to the trained generative model to generate a first latent vector;
presenting a sample target image to the trained generative model to generate a second latent vector;
modifying the second latent vector based on the first latent vector to generate a modified latent vector; and
generating an output image based on the modified latent vector.

14. The method of claim 13, wherein the set of training input images comprise standalone image images of one or more retail items or images of mannequins wearing the one or more retail items, and the set of training target images comprise corresponding catalogue images of the one or more retail items.

15. The method of claim 13, wherein the input image of the selected retail item is a standalone image of the selected retail item or an image of a mannequin wearing the selected retail item, and the output image is a catalogue image of a model wearing the selected retail item.

16. The method of claim 15, wherein the sample target image is a sample catalogue image of the model wearing another retail item, and is selected based one or more desired characteristics.

17. The method of claim 16, wherein the one on more desired characteristics comprise model pose, model skin tone, model body weight, model height, model body shape, accessories worn by the model, or background of the catalogue image.

18. The method of claim 13, wherein the input image of the selected retail item is a standalone image of the selected retail item and the output image is an image of the selected retail item worn by a shopper.

19. The method of claim 18, wherein the sample target image is an image of the shopper wearing another retail item, and is provided by the shopper.

20. The method of claim 13, wherein the input image of the selected retail item is a catalogue image of the selected retail item and the output image is a standalone image of the selected retail item.
